(19) United States
(12) Patent Application Publication
(10) Pub. No.: US 2026/0305728 A1
(43) Pub. Date: Oct. 8, 2026

(54) DEVICES, SYSTEMS, AND METHODS OF VAPORIZING A LIQUID AGENT

(71) Applicant: Pusha Company, LLC, Irvine, CA (US)

(72) Inventors: Kevin Chung, Diamond Bar, CA (US); Gadeer Nokari, Irvine, CA (US)

(21) Appl. No.: 19/637,920

(22) Filed: Apr. 2, 2026

Related U.S. Application Data
(60) Provisional application No. 63/783,909, filed on Apr. 4, 2025.

(51) Int. Cl. A24F 40/95; A24F 40/10; A24F 40/42; A24F 40/60; H02J 7/70

(52) U.S. Cl. CPC A24F 40/95; A24F 40/10; A24F 40/42; A24F 40/60; H02J 7/751

(57) ABSTRACT

A vaporizing device may include a pod. The pod can include a body portion extending between a first end and a second end. The first end can have an opening to provide an inhalable agent to a user and the second end can be configured to couple to an electricity source. The body can include a cap portion, a base, an inner chamber including a heating component and a plurality of inlet openings. The base can include an insert positioned at the second end of the body and extending between a first end and a second end. The first end of the insert can be closer to the second end of the body. The second end of the insert can include a tapered portion and a recessed portion forming a moat. The moat can be positioned proximate to the plurality of inlet openings. A reservoir can be defined within the body and configured to receive a vaping liquid such that the vaping liquid occupies at least a portion of the moat. The vaping device may include a battery device and/or a power bank.

### CROSS-REFERENCE TO RELATED APPLICATION

This application claims the benefit of priority of U.S. Provisional Application No. 63/783,909, titled “DEVICES, SYSTEMS, AND METHODS OF VAPORIZING A LIQUID AGENT,” filed Apr. 4, 2025, the entire disclosure of which is hereby incorporated by reference herein in its entirety. Any and all priority claims identified in the Application Data Sheet, or any corrections thereto, are hereby incorporated by reference under 37 CFR 1.57.

### BACKGROUND

### Field

The present disclosure is directed to devices, methods, and systems for vaporizing and delivering a liquid agent (commonly referred to as vape juice, vaping liquid, vaporizable liquid, e-juice, e-liquid, etc.) to a user, and more generally to devices referred to as electronic vaporizers, electronic vaping devices, vaporizers, etc.

### Certain Related Art

Systems and devices that vaporize liquid agents are used for a variety of purposes, including recreational and/or therapeutic purposes. For example, electronic vaporizers are commonly used to deliver oil-based vaporizable material (e.g., cannabis oils) and/or other vaporizable liquids (e.g., nicotine-based e-liquids, etc.) to the user for inhalation.

### SUMMARY

There is a need for an improved device, system, and/or method to efficiently deliver an inhalable agent, such as a vapor or aerosol (e.g., vaporized cannabis oil, cannabidiol (“CBD”) oil, delta-8 oil, nicotine-based e-liquids, etc.), to users. In some aspects, a vaporizing device can include a heating element that heats a vaporizable liquid (e.g., cannabis oil, CBD oil, delta-8 oil, nicotine-based e-liquids, etc.) so that it vaporizes and becomes inhalable by a user. The heating element may be positioned within an inner chamber in communication with a liquid reservoir. The inner chamber may receive vaporizable liquid from the reservoir through one or more inlet openings. The reservoir and inner chamber may be housed within a pod.

One concern relates to the discomfort that users experience when using vaporizing devices. For example, discomfort can present as dry burn, also referred to as dry hit. Dry burns can occur when a heating element (e.g., a coil) in the vaporizing device is not in sufficient contact with a vaporizable liquid, causing the user to experience an unpleasant taste. This can occur when there is insufficient vaporizable liquid in a liquid reservoir of the vaporizing device and/or when the device is positioned such that the vaporizable liquid moves away from the heating element (for example, on its side). For example, when the user places their electronic vaporizer on a horizontal surface, the device may be oriented such that the vaporizable liquid does not make proper contact with the heating element. For example, when placed on a horizontal surface, the vaporizable liquid may flow away from the heating element so that it does not make proper contact with the heating element. Further, certain vaporizable liquids, such as the oil-based vaporizable materials (e.g., cannabis oils) used in electronic vaporizers, typically include highly viscous liquids, which can cause the vaporizable liquid to take a longer time to travel back to contact the heating element after moving away from the heating element.

In certain embodiments, the liquid within a vaporizing device may be under vacuum. Breakage of the vacuum effect may occur when the liquid level is low and/or when the vaporizing device (or pod thereof) is laid on its side. In many instances, a user can place their device on a horizontal surface. As a result, the vaporizable liquid moves away from the inlet openings of the inner chamber in which the vaporizable liquid is vaporized, breaking the vacuum effect that was created when the vaporizable liquid had covered the inlet openings. This can result in potential leakage of the vaporizable liquid outside the reservoir, resulting in an unpleasant experience and loss of vaporizable liquid.

Another concern relates to the user's ability to see the level of vaporizable liquid in their device. As a user utilizes their vaporizing device, the liquid level in the reservoir drops, which can be an indication for the user to refill or replace the reservoir. However, observing the level of vaporizable liquid in the reservoir can be challenging. For example, while reservoirs can include transparent walls that would allow a user to see the level of vaporizable liquid therein, this may not be possible at night or in dark places.

Another concern relates to the user's ability to utilize their electronic vaporizer while it is secured in a power bank. Power banks are used to charge electronic vaporizers. Power banks can also have an advantage of securing the electronic vaporizer therein. However, when an electronic vaporizer is secured in a power bank, the user may not be able to utilize their device while the electronic vaporizer is being charged and/or without disconnecting (e.g., removing) the electronic vaporizer from the power bank.

Another concern relates to the shape and size of the pod that is used in electronic vaporizers. A pod that is long may occupy more space, for example, when placed in a user's pocket. A pod that is short can have the disadvantage of having a smaller reservoir. Accordingly, a pod that is short in the length direction and wide in the width direction (e.g., a cylindrical pod having a diameter of 16 mm) may be desired. However, the vaporizable liquid stored in a pod that includes a wide body may not make proper contact with the inlet opening(s) of the heating component, resulting in a dry burn, loss of vacuum effect, and other disadvantages.

In some embodiments, the techniques described herein relate to an electronic vaporizing assembly. The assembly can include a pod. The pod can include a first end and a second end opposite the first end. The pod can include a body portion extending between the first end and the second end. The first end can have an opening to provide an inhalable agent to a user and the second end can be configured to couple to an electricity source. In some embodiments, the body portion can include a cap portion, an inner chamber including a heating component and a plurality of inlet openings, a base, and an insert positioned at the second end of the body portion and extending between a first end and a second end. The first end of the insert can be closer to the second end of the body portion. The second end of the insert can include a tapered portion and a recessed portion forming a moat. The moat can be positioned proximate to the plurality of inlet openings. A reservoir can be defined within the body portion. The reservoir can be configured to receive a vaping liquid such that the vaping liquid occupies at least a portion of the moat.

A distance between an inner wall of the moat and the plurality of inlet openings can be less than a distance between an inner wall of the body portion and the plurality of inlet openings. The first end of the body portion can be a proximal end of the body portion and the second end of the body portion can be a distal end of the body portion, wherein a distal end of the moat is positioned distal to the plurality of inlet openings. A proximal end of the moat can be positioned proximal to a distal end of the plurality of inlet openings. A proximal end of the insert can be positioned distal to a proximal end of the plurality of inlet openings. The insert can be configured to prevent leakage of fluid through the base. The electronic vaporizing assembly can further include a battery device removably coupled to the pod. The electronic vaporizing assembly can further include a power bank, wherein the battery device is removably received within the power bank.

In some embodiments, the techniques described herein relate to an electronic vaporizing assembly. The assembly can include a power bank including a channel and a plurality of magnetic elements. The assembly can include a vaporizing device including a pod and/or a battery device. The battery device can include a plurality of magnetic elements. The plurality of magnetic elements of the battery device can be configured to interact with the plurality of magnetic elements of the power bank. In some embodiments, the battery device can be movable between a charging position and a use position without disconnecting the battery device from the power bank. The battery device can be magnetically coupled with the power bank in the first charging position and/or the second use position.

A user can switch between the charge position and the use position. The power bank can include four magnetic elements and the battery device can include two magnetic elements. A first magnetic element of the battery device can be configured to couple with a first magnetic element of the power bank in the charging position and a second magnetic element of the power bank in the use position, and a second magnetic element of the battery device can be configured to couple with a third magnetic element of the power bank in the charging position and a fourth magnetic element of the power bank in the use position. The first magnetic element of the power bank and the second magnetic element of the power bank can be positioned below the third magnetic element of the power bank and the fourth magnetic element of the power bank. The channel can include an open top end, wherein the pod extends above the open top end in the use position. The top end of the pod can be aligned with or positioned below a top end of the power bank in the charging position. A charging connector of the battery device can be aligned with a battery device connector of the power bank in the charging position. The power bank can include a light positioned to align with a transparent wall of the pod when the vaporizing device is in the charging position.

In some embodiments, the techniques described herein relate to an electronic vaporizing assembly. The assembly can include a vaporizing device. The device can include a pod. The pod can include a body extending between a first end and a second end. In some embodiments, the first end has an opening to provide an inhalable agent to a user, and the second end is configured to couple to an electricity source. The body can include a pod window including a transparent wall and positioned in the body. The pod window can be configured to at least partially define a reservoir for receiving a vaping liquid. In some embodiments, the assembly can include a battery device and/or a power bank. The power bank can include a light and a button configured to activate the light. The vaporizing device can be configured to couple to the power bank so that the transparent wall of the pod window aligns with the light so that the light illuminates the reservoir.

The power bank can include a channel configured to receive the vaporizing device, wherein the light is positioned within the channel. The vaporizing device can be configured to magnetically couple to the power bank. A charging connector of the battery device can be configured to align with a battery device connector of the power bank when the vaporizing device is coupled to the power bank so that the transparent wall of the pod window aligns with the light.

In some embodiments, the techniques described herein relate to an electronic vaporizing assembly to deliver a vaping liquid to a user, as shown and described herein.

In some embodiments, the techniques described herein relate to a method of storing a vaping liquid and delivering the vaping liquid to a user, as shown and described herein.

### BRIEF DESCRIPTION OF THE DRAWINGS

FIG. 1A illustrates a perspective view of a vaporizing assembly, including a vaporizing device positioned in a power bank, according to one aspect of the present disclosure.

FIG. 1B illustrates the assembly of FIG. 1A, with the vaporizing device separated from the power bank.

FIGS. 2A-2B illustrate some components of the vaporizing device according to one aspect of the present disclosure.

FIG. 3 illustrates a cross section of some components of a pod according to one aspect of the present disclosure.

FIG. 4A illustrates a cross section of some components of a pod according to one aspect of the present disclosure.

FIG. 4B illustrates an enlarged portion of the pod of FIG. 4A.

FIG. 5A illustrates a perspective view of some components of a battery device according to one aspect of the present disclosure.

FIG. 5B illustrates a cross section of some components of the vaporizing device according to one aspect of the present disclosure.

FIG. 6A illustrates a perspective view of some components of a power bank according to one aspect of the present disclosure.

FIG. 6B illustrates a cross section of some components of an electronic vaporizing assembly, including a pod, battery device, and power bank, according to one aspect of the present disclosure.

FIG. 7A illustrates a front view of some components of a power bank according to one aspect of the present disclosure.

FIG. 7B illustrates a cross section of some components of the power bank according to one aspect of the present disclosure.

FIG. 8A illustrates a front view of some components of a power bank and a vaporizing device according to one aspect of the present disclosure.

FIG. 8B illustrates a front view of some components of a power bank and a vaporizing device, with the vaporizing device positioned in the power bank, according to one aspect of the present disclosure.

FIG. 9A illustrates a front view of some components of the power bank and the battery device, with some internal components visible for illustration purposes.

FIG. 9B illustrates a perspective view of the vaporizing assembly, with the vaporizing device in a first position.

FIG. 9C illustrates a perspective view of the vaporizing assembly, with the vaporizing device in a second position.

FIG. 10A illustrates a perspective view of the vaporizing assembly, with the vaporizing device in a first position.

FIG. 10B illustrates a perspective view of the vaporizing assembly, with the vaporizing device in a second position.

### DETAILED DESCRIPTION

Disclosed below is a vaporizing assembly. In one implementation, the vaporizing assembly can include a vaporizing device and a power bank. The vaporizing device can include a pod and a battery device. In certain embodiments, the vaporizing device may be referred to as a vaporizer.

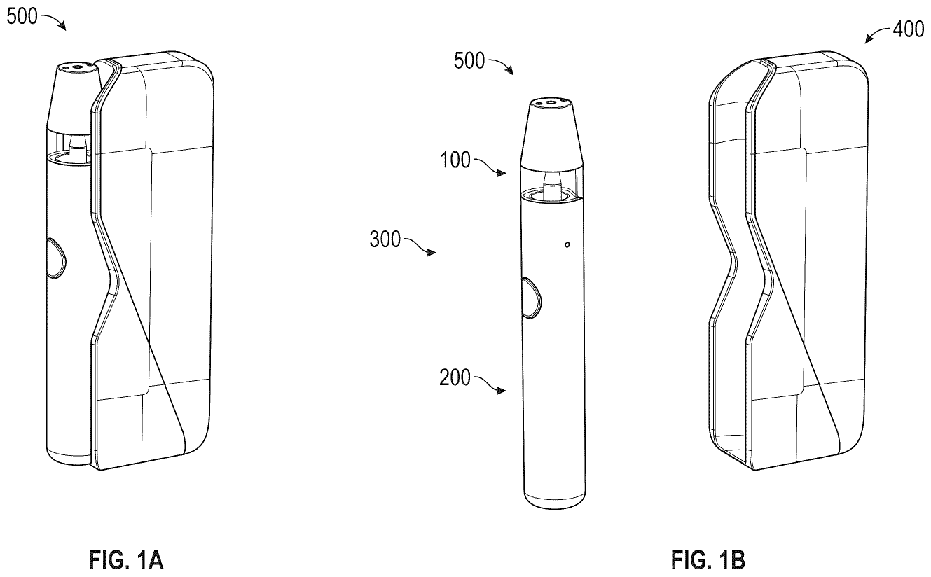

FIG. 1A illustrates a perspective view of an electronic vaporizing assembly 500, including a vaporizing device 300 positioned in a power bank 400, according to one aspect of the present disclosure. The vaporizing device 300 can include a pod 100, and a battery device 200 coupled to the pod 100. The battery device 200 may include one or more batteries or battery packs. The power bank 400 can provide an energy source for the vaporizing device 300 (e.g., to charge the battery device 200). In some aspects, the vaporizing device 300 can be positioned in the power bank 400 to receive energy (e.g., electricity, electric power, etc.) from the power bank 400. FIG. 1B illustrates the assembly of FIG. 1A, with the vaporizing device 300 separated from the power bank 400.

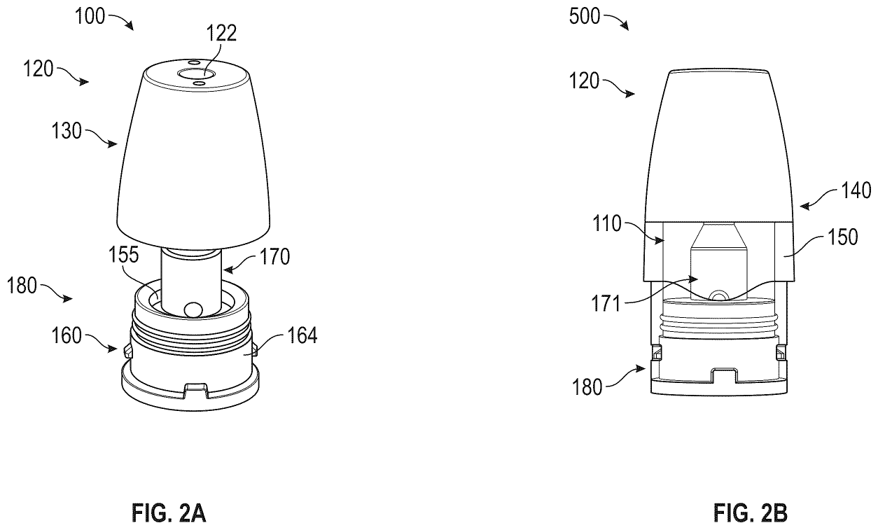

FIGS. 2A-2B illustrate some components of the vaporizing device according to one aspect of the present disclosure. The vaporizing device 300 can include a pod 100. The pod 100 can include a first end 120 and a second end 180. The first end 120 may also be referred to as a proximal end and the second end 180 may be referred to as a distal end. A direction from the first end 120 towards the second end 180 may be referred to as a distal direction, and a direction from the second end 180 towards the first end 120 may be referred to as the proximal direction. For example, a component that is further in the distal direction from the first end 120 than a second component may be referred to as distal to the second component. A component having a first end or surface that is proximal to a second end or surface may be described as having a proximal end or proximal surface (referring to the first end or surface) and a distal end or distal surface (referring to the second end or surface).

A body or body portion 140 can extend between the first end 120 and the second end 180. In some aspects, the body portion 140 can include a cap 130, a base 160, and a wall 150 extending between the cap 130 and the base 160. An opening 122 can be positioned in the cap 130 at the first end 120 to accommodate the flow of an inhalable agent to a user. The inhalable agent may be a vapor or aerosol resulting from the vaporization of a vaporizable liquid (e.g., cannabis oils, CBD oil, delta-8 oil, nicotine-based e-liquids, etc.).

The pod 100 can include the cap 130, a wall 150, and the base 160. The cap 130, the wall 150, and the base 160 can be manufactured from different materials and in a variety of shapes. In some aspects, the cap 130 can be manufactured to a conical or frustoconical shape. In some aspects, the base 160 can be manufactured to a generally cylindrical shape. In some aspects, the cap 130 and/or the base 160 can be manufactured from rigid plastic material, including, but not limited to, Polyvinyl Chloride (PVC), Polystyrene (PS), Polyethylene (PE), Acrylonitrile Butadiene Styrene (ABS), Polypropylene (PP), Polycarbonate (PC), etc.

In some aspects, the wall 150 (or at least a portion thereof) can include transparent materials such as plastic materials (e.g., acrylic, also known as Plexiglas, or polycarbonate) that allow light through them. The transparent portion of the wall 150 may be referred to as a pod window. Advantageously, when the wall 150 is manufactured to include transparent materials, the user will be able to see the level of vaporizable liquid remaining in the pod 100. In some aspects, the wall 150 can be manufactured to include an impermeable material to restrain leakage of vaporizable liquid from the pod 100. The wall 150 can define a reservoir that contains a liquid agent. In some aspects, the cap 130, wall 150, and base 160 form a sealed assembly that restrains leakage of the liquid agent and/or air (other than through the opening 122) from the pod 100.

Referring to FIG. 2A, in certain embodiments, the pod 100 can include an inner chamber 170. The inner chamber 170 can be a heating component or can include a heating component. Heat can be applied to vaporizable liquid within the inner chamber 170 to vaporize the vaporizable liquid to allow for inhalation by a user. The vaporized liquid may flow through an outlet 172 of the inner chamber 170 for inhalation.

The inner chamber 170 can be positioned between the cap 130 and the base 160. In one example, the inner chamber 170 can include or communicate with an atomizer that includes a coil and can convert electrical energy from the battery device 200 to heat. The inner chamber 170 can include an inlet system 171 (not illustrated in FIG. 2A but see FIG. 2B). It is noted that for illustrative purposes, the wall 150 is not shown in FIG. 2A, but it can be seen in FIG. 2B.

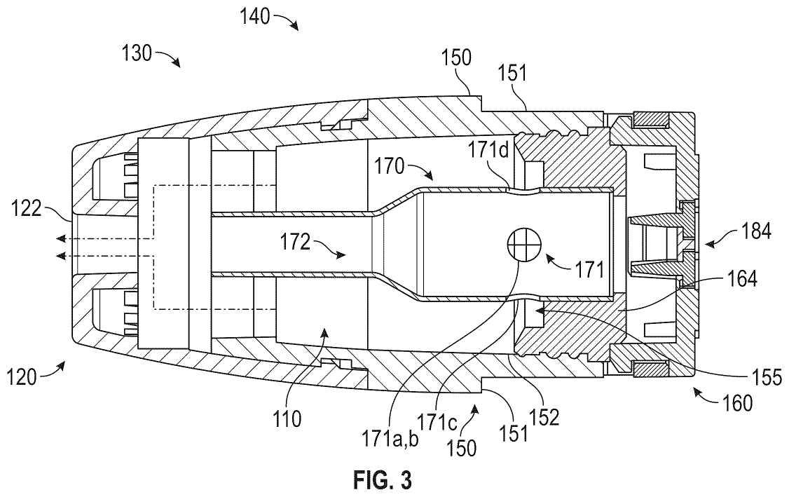

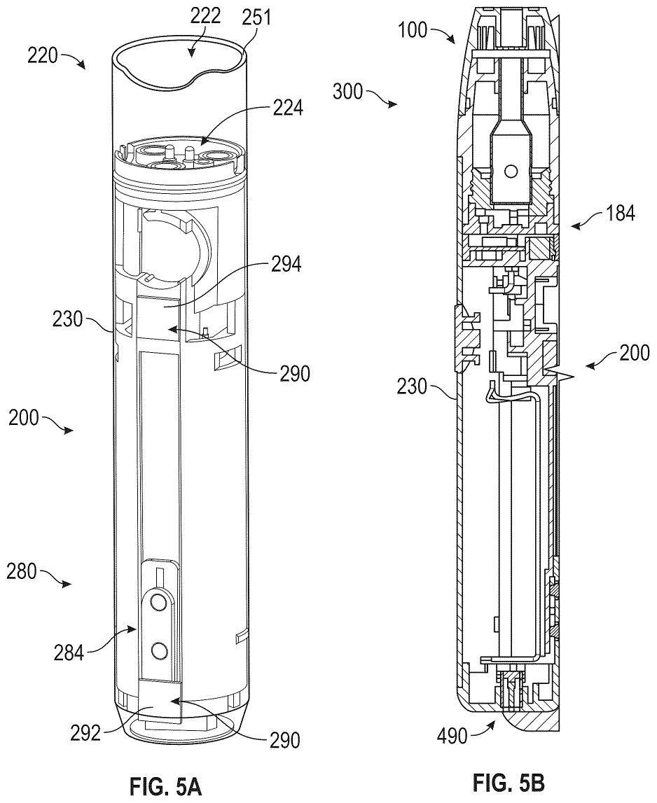

FIG. 3 illustrates a cross-section of some components of the vaporizing device according to one aspect of the present disclosure. More specifically, FIG. 3 illustrates a cross-section through the pod 100. As discussed above, the body portion 140 can include the cap 130, the wall 150, and the base 160. The wall 150 can include an edge portion 151. The edge portion 151 can cooperate with a corresponding receiving portion 251 (see FIG. 5A) to secure the pod 100 in the vaporizing device 300. The wall 150 can further include an interior portion 152. The space between the exterior surface of the inner chamber 170 and the interior portion 152 of the wall 150 can at least partially define a reservoir 110. The reservoir 110 can be used to store the vaporizable liquid therein.

Still referring to FIG. 3, the inlet system 171 of the inner chamber 170 can include a plurality of inlet openings, such as a first inlet 171a, a second inlet 171b, a third inlet 171c, and/or a fourth inlet 171d. In some aspects, the first inlet 171a can be positioned opposite the second inlet 171b such that a straight line can pass through the center of the first inlet 171a and the second inlet 171b. Similarly, the third inlet 171c can be positioned opposite the fourth inlet 171d such that a straight line can pass through the center of the third inlet 171c and the fourth inlet 171d.

In certain embodiments, the pod 100 can include an insert 164. The insert 164 can be positioned within the wall 150 adjacent to the base 160. The insert 164 can define a bottom end of the reservoir 110. The insert 164 can prevent fluid from leaking from the reservoir 110 through the base 160.

In certain embodiments, the pod 100 can include a moat 155. The moat 155 may at least partially surround (for example, encircle) the inlet system 171 (e.g., the inlet openings 171a-d). In certain embodiments, the moat 155 may be formed by a carved-out or recessed portion of the insert 164 positioned adjacent to the inlet system 171, encircling the inner chamber 170. The inventors of the present disclosure unexpectedly discovered that the presence of the moat 155 adjacent to the inner chamber 170 can have several advantages. For example, in the absence of the moat 155, when the pod 100 is oriented horizontally (e.g., when a user places the pod 100 on its side on a table), the liquid agent in the reservoir 110 can be accumulated along the interior portion 152 and away from the inlet system 171. Consequently, the vaporizable liquid in the reservoir 110 may not make proper contact with the inner chamber 170, resulting in a dry burn and/or breakage of the vacuum effect. Advantageously, the moat 155 can allow at least a portion of a highly viscous vaporizable liquid (e.g., certain oil-based vaporizable liquids, such as cannabis oil) to remain adjacent to the inlet system 171 of the inner chamber 170, increasing the likelihood that the heating components of the inner chamber 170 remain wet for a longer period. For example, the moat 155 provides for a smaller distance between a surface 163 of the insert 164 and the inlet openings 171a-d than between the interior portion 152 of the wall 150 and the inlet openings 171a-d, which can allow contact of the vaporizable liquid with the heating component with lesser amounts of vaporizable liquid within the reservoir than in the absence of the moat 155. Further, due to the high viscosity of the vaporizable liquid, vaporizable liquid within the moat 155 may remain in the moat for extended periods of time, for example, to maintain contact with the heating component when the pod 100 is turned on its side.

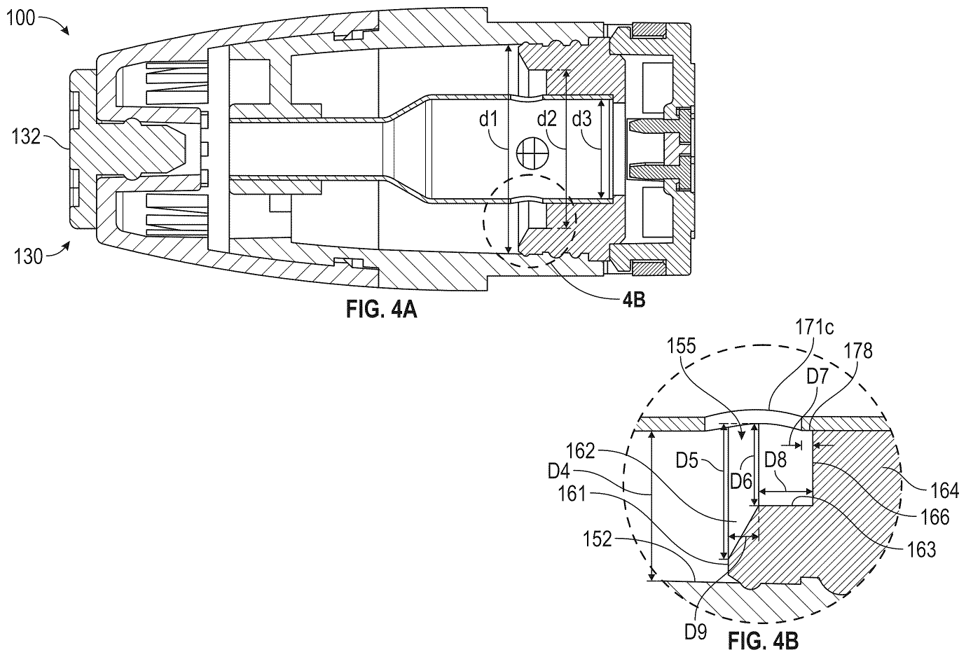

FIG. 4A illustrates a cross section of some components of the pod 100 according to one aspect of the present disclosure. In one example, the cap 130 can include a cover 132 removably coupled with the pod 100. Advantageously, the cover 132 can inhibit the flow of unwanted particles to the interior of the pod 100 and/or help maintain a cleaner surface at or around the opening 122, thereby facilitating a more sanitary contact between the mouth of the user and the pod 100.

Still referring to FIG. 4A, in one example, the pod 100 can be manufactured to have the following exemplary dimensions illustrated in FIG. 4A:
about 11.80 mm corresponding to the inner wall of the pod 100 adjacent to the insert 164 (d1);
about 8.94 mm corresponding to the inner diameter of the moat 155 (d2); and
about 5.59 mm corresponding to the inner diameter of the inner chamber 170 (d3).

Referring now to FIG. 4B, an enlarged portion of the pod of FIG. 4A and the following exemplary dimensions are illustrated:
about 2.83 mm corresponding to the distance D4 between the interior portion 152 and the inlet opening 171c (which can be the same distance between the interior portion 152 and the other inlet openings 171a, 171b, and 171d);
about 2.49 mm corresponding to the distance D5 between the top portion of the insert 164 and the inlet opening 171c (which can be the same distance between the top portion of the insert 164 and the other inlet openings 171a, 171b, and 171d);
about 0.60 mm corresponding to the height D9 of the tapered side 162 of the insert 164 from the moat 155 to the top side 161 of the insert 164;
about 0.99 mm corresponding to the height D8 of the moat 155 (e.g., the height of the side wall 163 of the moat 155);
about 1.53 mm corresponding to the distance D6 between the inner wall of the moat 155 and the inlet system 171 (e.g., the width of the bottom surface 166 of the moat 155); and
about 0.20 mm corresponding to the distance D7 between the bottom of the moat and the bottom of the inlet opening 171c (e.g., the height of the offset portion 178) (which can be the same distance between the bottom of the moat and the other inlet openings 171a, 171b, and 171d).

The shape and dimensions of the insert 164 and moat 155 may provide for a moat 155 that maintains vaporizable liquid in contact with the inner chamber 170 and/or the heating component for extended periods of time regardless of the positioning of the pod 100 (for example, if the pod 100 is upright or on its side). Maintaining the vaporizable liquid in contact with the inner chamber 170 can prevent the loss of vacuum or reduce the risk of loss of vacuum. Maintaining the vaporizable liquid in contact with the heating component can prevent or reduce the risk of dry burn.

FIG. 5A illustrates an embodiment of the battery device 200. The battery device 200 can include a rechargeable battery (e.g., a lithium-ion battery) to supply electrical current to the pod 100 (e.g., to the heating component for the inner chamber 170), which heats the liquid agent. In some aspects, the battery device 200 can have a first end 220, a second end 280, and a body that extends between the first end 220 and the second end 280. The battery device 200 can include a pod connector 224. The battery device 200 can include a charging connector 284. The battery device 200 can include a magnetic connection system 290. In some aspects, the body can include an outer wall 230 which can house one or more components of the battery device 200 (e.g., the pod connector 224, the charging connector 284, the magnetic connection system 290, a lithium-ion battery, etc.) The outer wall 230 can be manufactured from a variety of materials (e.g., rigid plastic) and include different properties (e.g., transparent, opaque, etc.), and shapes (e.g., cylindrical). Once a user places the pod 100 in the battery device 200 through an opening 222, a receiving portion 251 of the outer wall 230 at the first end 220 can cooperate with the edge portion 151 to secure the second end 180 of the pod 100 in the battery device 200. The battery device can further include an activator, such as a button, that can be actuated (e.g., pressed) to activate the vaporizing device 300 (e.g., activate the heating component of the vaporizing device 300).

FIG. 5B illustrates a cross section of some components of the vaporizing device 300, including the pod 100 and the battery device 200. In the illustrated example of FIG. 5B, the pod 100 is secured in the battery device 200. The pod connector 224 of the battery device 200 is coupled with the battery device connector 184 of the pod 100 to facilitate the flow of electric current and subsequent charging of the pod 100. Also illustrated in FIG. 5B is a base portion 490 of a power bank 400 that can support the vaporizing device 300.

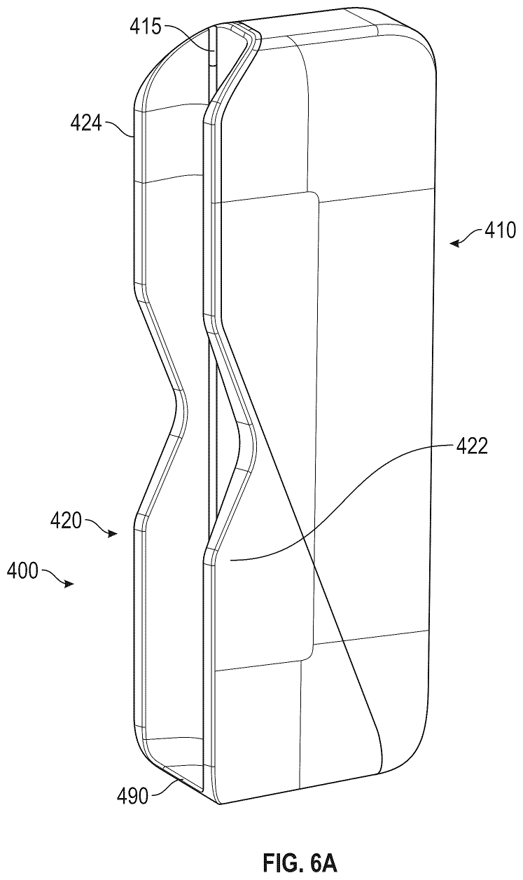

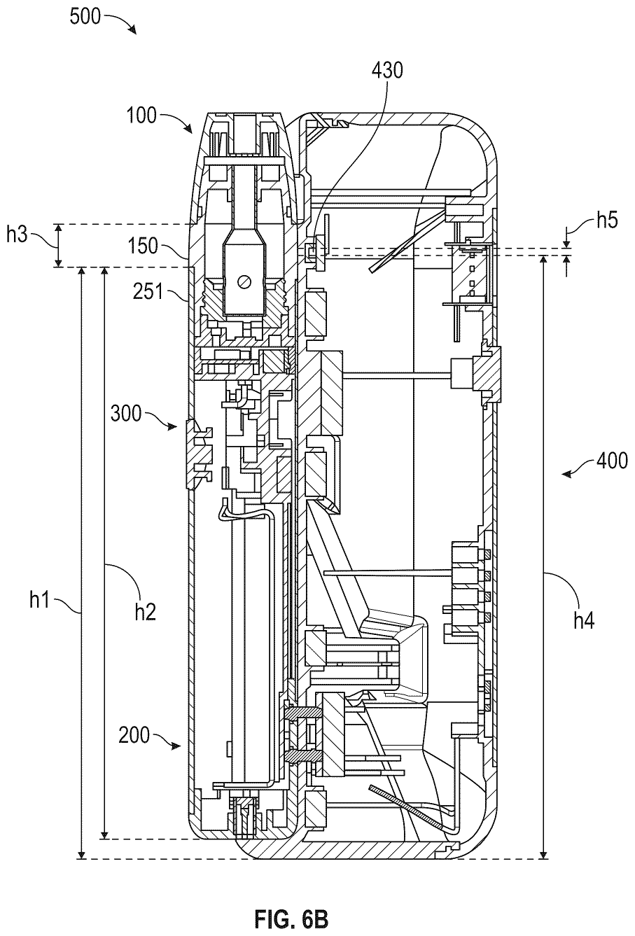

FIG. 6A illustrates a perspective view of a power bank 400 according to one aspect of the present disclosure. The power bank 400 can include a body 410. The power bank 400 can include an open top 415. The power bank 400 can include a first side 422. The power bank 400 can include a second side 424. The power bank 400 can include a base portion 490. The power bank 400 can include a channel 420 that can be configured to receive the vaporizing device 300. The first side 422, the second side 424, and the base portion 490 can form the channel 420.

FIG. 6B illustrates a cross section of some components of the electronic vaporizing assembly 500, including the vaporizing device 300 and the power bank 400. In some aspects, the power bank 400 can include an illuminating feature, such as a light 430. In one example, the electronic vaporizing assembly 500 can be manufactured to have the following exemplary dimensions illustrated in FIG. 6B:
about 85.00 mm corresponding to the height from the bottom of the base portion 490 to the receiving portion 251 (h1);
about 82.10 mm corresponding to the height from the top of the base portion 490 to the receiving portion 251 (h2);
about 6.15 mm corresponding to the height of the wall 150 (h3);
about 86.60 mm corresponding to the height from the bottom of the base portion 490 to the bottom of the light 430 (h4); and
about 0.85 mm corresponding to the height of the light 430 (h5).

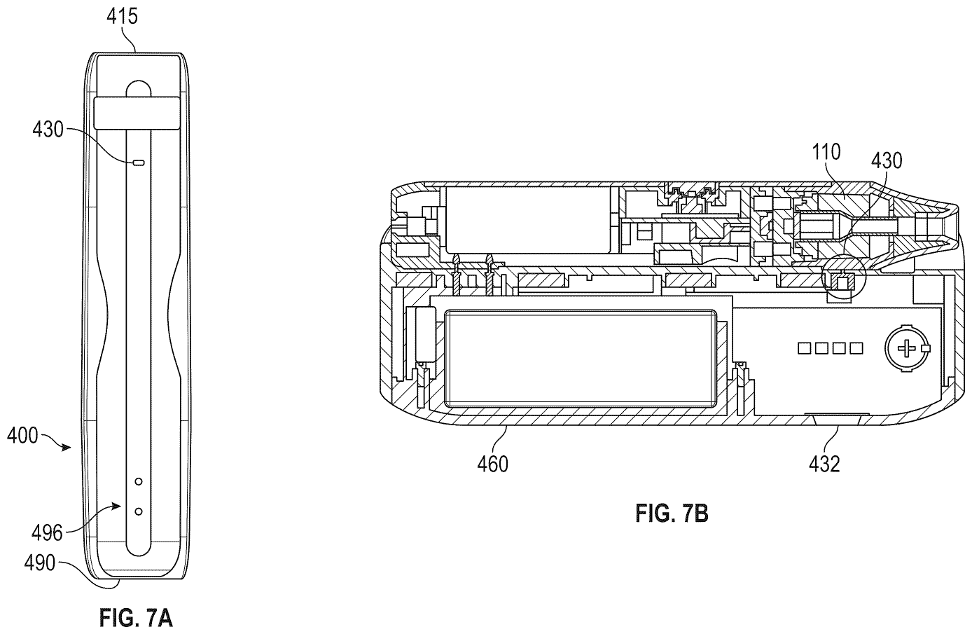

FIG. 7A illustrates a front view of some components of the power bank 400. In some embodiments, the power bank 400 can include a light 430. The light 430 can be positioned proximate the open top 415 and a battery device connector 496 proximate the base portion 490. The light 430 can be activated to provide for increased visibility in dark environments.

As discussed above, in some aspects, the wall 150 of the pod 100 can be manufactured to include transparent materials. Advantageously, the light 430 can be positioned to illuminate the reservoir 110 when the vaporizing device is received within the channel 420. The light 430 can illuminate the liquid agent stored in the reservoir 110 through the transparent portion of the wall 150, thereby allowing a user to see the level of liquid agent remaining in the reservoir 110 in a dark environment.

FIG. 7B illustrates a cross section of some components of the power bank 400, including the light 430. A light activator 432 (e.g., a button) can be positioned on a rear surface 460 of the power bank 400. The light activator 432 can be configured to activate illumination of the light 430 in the power bank 400 using a variety of mechanisms. In some aspects, the light activator 432 can be a button and configured to activate through an applied pressure (e.g., when a user presses the button).

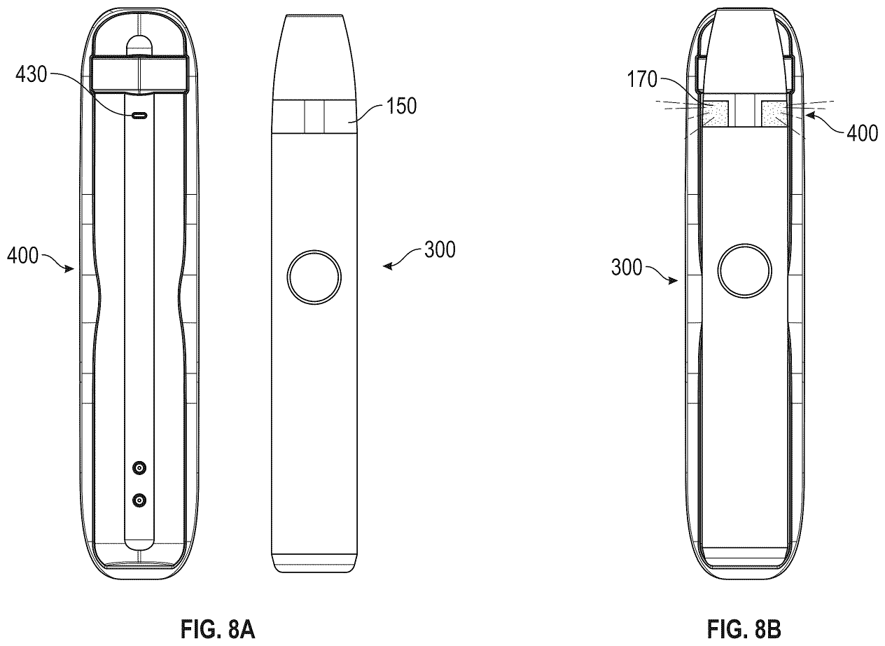

FIG. 8A illustrates a front view of some components of the power bank 400 and the vaporizing device 300, including the light 430 and the wall 150. In the illustrated example of FIG. 8A, the wall 150 of the pod 100 includes transparent materials. The light 430 can have other advantages in addition to enabling a user to see the level of liquid agent in the reservoir 110. For example, when the power bank 400 is equipped with a light 430 and the vaporizing device 300 is not positioned in the power bank 400, the light 430 can be used as a conventional flashlight to aid the user in dark environments.

FIG. 8B illustrates some components of FIG. 8A, with the vaporizing device 300 positioned in the power bank 400, and the light 430 illuminating the reservoir 110.

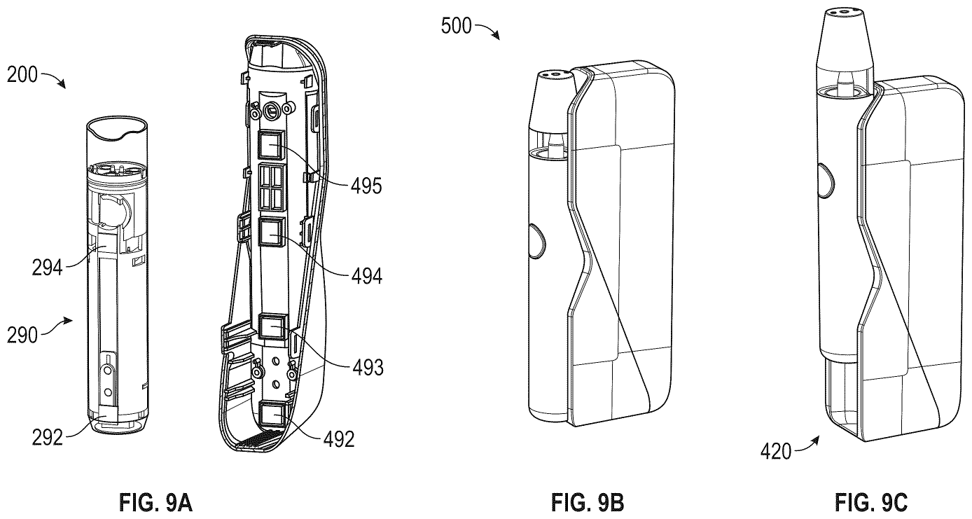

FIG. 9A illustrates a front view of some components of the battery device 200 and power bank 400, with some internal components visible for illustration purposes. As discussed above, in some embodiments, the battery device 200 can include a magnetic connection system 290. The magnetic connection system 290 can include a plurality of magnetic elements, such as a first magnetic element 292 and a second magnetic element 294. The magnetic elements 292 and 294 may each include one or more magnets (e.g., earth magnets). The magnets can be Neodymium Iron Boron magnets. The magnets may have silver nickel plating. The magnetic connection system 290 can couple (e.g., magnetically and/or mechanically) with a corresponding magnetic connection system of the power bank 400 to secure the battery device 200 in the power bank 400. In some embodiments, the magnetic connection system of the power bank 400 can include a first set of magnetic elements 492 and 494. The magnetic elements 492 and 494 may each include one or more magnets (e.g., earth magnets). The magnets can be Neodymium Iron Boron magnets. The magnets may have silver nickel plating. The magnetic elements 292 and 294 can magnetically couple with the magnets 492 and 494, respectively, to secure the vaporizing device 300 within the power bank 400 (e.g., within the channel 420 of the power bank 400) as shown in FIG. 9B.

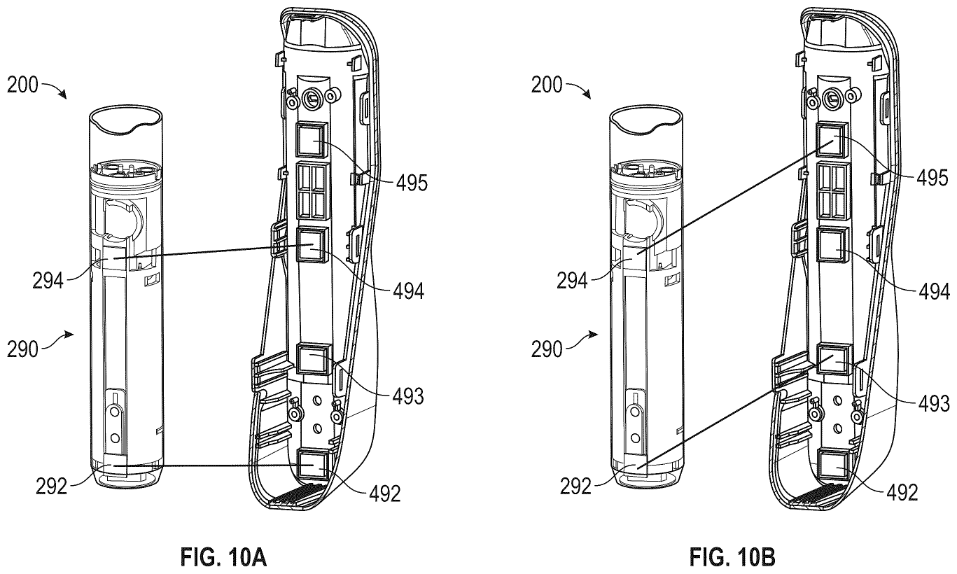

In some embodiments, the power bank 400 can include a second set (or additional sets) of magnetic elements, including a magnetic element 493 positioned above the first magnetic element 492, and a magnetic element 495 positioned above the second magnetic element 494. The magnetic elements 493 and 495 may each include one or more magnets (e.g., earth magnets). The magnets can be Neodymium Iron Boron magnets. The magnets may have silver nickel plating. The magnetic elements 292 and 294 can magnetically couple with the magnetic elements 493 and 495, respectively, to secure the vaporizing device 300 within the power bank 400 (e.g., within the channel 420 of the power bank 400) as shown in FIG. 9C. This arrangement of magnetic elements allows a user to move (e.g., slide) the vaporizing device 300 in the channel 420 of the power bank 400 without removing the vaporizing device 300 from the power bank 400. For example, the vaporizing device 300 can slide from a first position (see FIG. 9B) to a second position (see FIG. 9C). In the first position, the first magnetic element 292 is coupled with the first magnetic element 492, and the second magnetic element 294 is coupled with the second magnetic element 494. See FIG. 10A. The user can slide the vaporizing device 300 in the channel 420 to a second position, where the first magnetic element 292 is coupled with the third magnetic element 493, and the second magnetic element 294 is coupled with the fourth magnetic element 495. See FIG. 10B. Similarly, the vaporizing device 300 can be slid from the second position to the first position.

In the first position, the charging connector 284 of the battery device 200 can align with the battery device connector 496 of the power bank 400 so that the vaporizing device 300 is charged by the power bank 400. In the first position, the reservoir 110 may be aligned with the light 430.

In the second position, at least a portion of the pod 100, including the opening 122, can be positioned above the power bank 400 to facilitate use of the vaporizing device 300 while the vaporizing device is positioned within the power bank 400.

Advantageously, the ability to slide between two positions using the magnetic coupling arrangements described herein can allow the user to utilize (e.g., activate) the vaporizing device 300 while it is secured in the power bank 400 and switch between a charging mode and a use mode without disconnecting the vaporizing device 300.

While certain embodiments of the inventions have been described, these embodiments have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein. Moreover, as should be apparent, the features and attributes of the specific aspects disclosed herein may be combined in different ways to form additional aspects, all of which fall within the scope of the present disclosure.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” “proximate”, and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain arrangements, the terms “generally parallel” and “substantially parallel” refer to a value, amount, or characteristic that departs from exactly parallel by less than or equal to 15°, 10°, 5°, 3°, 1 degree, or 0.1 degree. The ranges disclosed herein also encompass any and all overlap, sub-ranges, and combinations thereof, and any specific values within those ranges. Language such as “up to,” “at least,” “greater than,” “less than,” “between,” and the like includes the number recited. Numbers and values used herein preceded by a term such as “about” or “approximately” include the recited numbers. For example, “approximately 7 mm” includes “7 mm” and numbers and ranges preceded by a term such as “about” or “approximately” should be interpreted as disclosing numbers and ranges with or without such a term in front of the number or value such that this application supports claiming the numbers, values and ranges disclosed in the specification and/or claims with or without the term such as “about” or “approximately” before such numbers, values or ranges such, for example, that “approximately two times to approximately five times” also includes the disclosure of the range of “two times to five times.”

The scope of the present disclosure is not intended to be limited by the specific disclosures of preferred embodiments in this section or elsewhere in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An electronic vaporizing assembly, comprising:
a power bank comprising a channel and a plurality of magnetic elements; and
a vaporizing device comprising:
a pod; and
a battery device, the battery device comprising a plurality of magnetic elements, the plurality of magnetic elements of the battery device configured to interact with the plurality of magnetic elements of the power bank;
wherein the battery device is movable between a charging position and a use position without disconnecting the battery device from the power bank, the battery device magnetically coupled with the power bank in the charging position and the use position.

2. The electronic vaporizing assembly of claim 1, wherein the power bank comprises four magnetic elements and the battery device comprises two magnetic elements.

3. The electronic vaporizing assembly of claim 2, wherein:
a first magnetic element of the battery device is configured to couple with a first magnetic element of the power bank in the charging position and a second magnetic element of the power bank in the use position; and
a second magnetic element of the battery device is configured to couple with a third magnetic element of the power bank in the charging position and a fourth magnetic element of the power bank in the use position.

4. The electronic vaporizing assembly of claim 3, wherein the first magnetic element of the power bank and the second magnetic element of the power bank are positioned below the third magnetic element of the power bank and the fourth magnetic element of the power bank.

5. The electronic vaporizing assembly of claim 3, wherein the channel comprises an open top end, wherein the pod extends above the open top end in the use position.

6. The electronic vaporizing assembly of claim 3, wherein a top end of the pod is aligned with or positioned below a top end of the power bank in the charging position.

7. The electronic vaporizing assembly of claim 3, wherein a charging connector of the battery device is aligned with a battery device connector of the power bank in the charging position.

8. The electronic vaporizing assembly of claim 3, wherein the power bank comprises a light positioned to align with a transparent wall of the pod when the vaporizing device is in the charging position.

9. An electronic vaporizing assembly, comprising:
a pod, the pod comprising:
a first end and a second end opposite the first end; and
a body portion extending between the first end and the second end, wherein the first end has an opening to provide an inhalable agent to a user and the second end is configured to couple to an electricity source, the body portion comprising:
a cap portion;
an inner chamber comprising a heating component and a plurality of inlet openings;
a base;
an insert positioned at the second end of the body portion and extending between a first end and a second end, the first end of the insert being closer to the second end of the body portion, wherein the second end of the insert comprises a tapered portion and a recessed portion forming a moat, the moat positioned proximate to the plurality of inlet openings; and
a reservoir defined within the body portion, the reservoir configured to receive a vaping liquid such that the vaping liquid occupies at least a portion of the moat.

10. The electronic vaporizing assembly of claim 9, wherein a distance between an inner wall of the moat and the plurality of inlet openings is less than a distance between an inner wall of the body portion and the plurality of inlet openings.

11. The electronic vaporizing assembly of claim 9, wherein the first end of the body portion is a proximal end of the body portion and the second end of the body portion is a distal end of the body portion, wherein a distal end of the moat is positioned distal to the plurality of inlet openings.

12. The electronic vaporizing assembly of claim 11, wherein a proximal end of the moat is positioned proximal to a distal end of the plurality of inlet openings.

13. The electronic vaporizing assembly of claim 12, wherein a proximal end of the insert is positioned distal to a proximal end of the plurality of inlet openings.

14. The electronic vaporizing assembly of claim 9, wherein the insert is configured to prevent leakage of fluid through the base.

15. The electronic vaporizing assembly of claim 9, further comprising a battery device removably coupled to the pod.

16. The electronic vaporizing assembly of claim 15, further comprising a power bank, wherein the battery device is removably received within the power bank.

17. An electronic vaporizing assembly, comprising:
a vaporizing device, comprising:
a pod, the pod comprising:
a body extending between a first end and a second end, wherein the first end has an opening to provide an inhalable agent to a user and the second end is configured to couple to an electricity source, the body comprising:
a pod window comprising a transparent wall positioned in the body, the pod window configured to at least partially define a reservoir for receiving a vaping liquid; and
a battery device; and
a power bank comprising a light and a button configured to activate the light;
wherein the vaporizing device is configured to couple to the power bank so that the transparent wall of the pod window aligns with the light so that the light illuminates the reservoir.

18. The electronic vaporizing assembly of claim 17, wherein the power bank comprises a channel configured to receive the vaporizing device, wherein the light is positioned within the channel.

19. The electronic vaporizing assembly of claim 17, wherein the vaporizing device is configured to magnetically couple to the power bank.

20. The electronic vaporizing assembly of claim 17, wherein a charging connector of the battery device is configured to align with a battery device connector of the power bank when the vaporizing device is coupled to the power bank so that the transparent wall of the pod window aligns with the light.
